(19) United States
(12) Patent Application Publication
(10) Pub. No.: US 2017/0216748 A1
(43) Pub. Date: Aug. 3, 2017

(54) Filter Element, in Particular for Gas Filtration

(71) Applicant: MANN+HUMMEL GMBH, Ludwigsburg (DE)

(72) Inventors: Robert Hasenfratz, Waiblingen (DE); Fabian Wagner, Moeglingen (DE)

(21) Appl. No.: 15/486,354

(22) Filed: Apr. 13, 2017

Related U.S. Application Data
(63) Continuation of application No. PCT/EP2015/073611, filed on Oct. 13, 2015.

(30) Foreign Application Priority Data
Oct. 13, 2014 (DE) 10 2014 014 957.9

(51) Int. Cl. B01D 46/00; B01D 46/12; F02M 35/024; B01D 46/52

(52) U.S. Cl. CPC B01D 46/002; B01D 46/521; B01D 46/12; B01D 46/0005; F02M 35/024; B01D 2267/70; B01D 2279/60

(57) ABSTRACT

A filter element has a filter element housing with first and second outwardly open receiving pockets. A first filter medium body is disposed in the first receiving pocket. A second filter medium body is disposed in the second receiving pocket. The first and second filter medium bodies delimit a common clean chamber that communicates with an outflow opening for purified fluid. The first receiving pocket has a circumferential first support rim on which the first medium body is supported. The second receiving pocket has a circumferential second support rim on which the second filter medium body is supported. The first receiving pocket has a first receiving wall partially enclosing the first filter medium body and extending outwardly away from the first support rim. The second receiving pocket has a second receiving wall partially enclosing the second filter medium body and extending outwardly away from the second support rim.

### CROSS-REFERENCE TO RELATED APPLICATIONS

This application is a continuation application of international application No. PCT/EP2015/073611 having an international filing date of 13 Oct. 2015 and designating the United States, the international application claiming a priority date of 13 Oct. 2014, based on prior filed German patent application No. 10 2014 014 957.9, the entire contents of the aforesaid international application and the aforesaid German patent application being incorporated herein by reference.

### BACKGROUND OF THE INVENTION

The invention concerns a filter element, in particular for gas filtration, with a first filter medium body and a second filter medium body on a common filter element housing, wherein the first and second filter medium bodies delimit a common clean chamber from where the purified fluid is to be discharged by means of at least one outflow opening.

DE 10 2011 083 657 A1 discloses a filter element for a fresh air device of a vehicle that comprises, on a support body, two separately embodied filter medium bodies configured as folded filters and arranged diagonally opposed on the support body and delimiting an intermediately positioned clean chamber in the support body. The air to be purified flows through the filter medium bodies from the exterior to the interior and is discharged axially by a discharge opening from the clean chamber.

The support body of the filter element is configured as a frame with two parallel extending webs that at their end faces are connected to an end face plate, respectively, wherein one of the end face plates is provided with the discharge opening for discharging the purified air. The support body is configured as an injection molded plastic component that is injection molded onto the two filter medium bodies. By injection molding, a flow-tight connection between the outflow side of each filter medium body and the support frame is produced.

### SUMMARY OF THE INVENTION

It is the object of the invention to provide a filter element of a compact configuration with high filtration performance.

This object is solved according to the invention in that the first filter medium body and the second filter medium body each are received in an outwardly open receiving pocket on the filter element housing and the receiving pockets comprise a receiving wall that at least partially encloses the filter medium bodies and extends outwardly from a circumferentially extending support rim in the receiving pockets on which the filter medium bodies are resting.

The dependent claims provide expedient further embodiments.

The filter element according to the invention is preferably used for gas filtration, for example, for filtration of the combustion air for an internal combustion engine or for purifying the fresh air which is supplied to cabins such as vehicle interiors. However, use for filtration of liquids is also possible.

The filter element comprises a first filter medium body and a second filter medium body that are embodied separate from each other and are each realized as an individual body. The two filter medium bodies are inserted into a common filter element housing of the filter element that forms a support body and delimit a common clean chamber from which the purified fluid is discharged by means of an outflow opening in the filter element housing from the filter element.

Receiving pockets are provided in the filter element housing into which the filter medium bodies are inserted. Each filter medium body has correlated therewith its own receiving pocket in which the filter medium bodies are safely held and received and a flow-tight connection between filter medium body and receiving pocket can be realized in order to avoid leakage flows between the raw side and the clean side of the filter medium body. By arranging two filter medium bodies on the filter element, the raw side or inflow side is enlarged; also, with improved filtration performance, the filter element can be adapted better to different installation spaces.

The receiving pockets are designed to be open in outward direction so that the filter medium bodies can be inserted from the exterior into the receiving pockets. In inward direction, the receiving pockets are in flow communication with the clean chamber so that the fluid passing through the filter medium bodies can reach the clean chamber via the clean side of the filter medium bodies. Advantageously, the receiving pockets immediately adjoin the clean chamber.

The receiving pockets have a receiving wall that at least partially encloses the filter medium bodies and extends in outward direction at the receiving pockets. The filter medium bodies are contacting a circumferentially extending support rim which is formed in the receiving pockets; the receiving wall is arranged adjacent to the support rim. By means of the support rim an exact positioning of the filter medium bodies is ensured. Also, a flow-tight reception of the filter medium body in the receiving pocket can be ensured, as needed by means of an adhesive connection or by foaming.

The support rims are in particular embodied to extend completely circumferentially, i.e., they have no breaks. Especially, the support rims are positioned in a plane, respectively.

It can be expedient that the inner contour of the receiving pockets matches the outer contour of the respectively received filter medium body. This ensures safe receiving and holding of the filter medium bodies in the receiving pockets transverse to the flow direction, in particular a form-fit reception. At the same time, the risk of undesirable leakage flows between raw side and clean side is reduced.

Possible is however also an embodiment in which the receiving pockets and the filter medium bodies have deviating contours and/or sizes so that at least partially a gap between the outer side of a filter medium body and the inner side of the receiving wall of the receiving pocket exists. Since the filter medium body is supported on the support rim, it is however ensured that raw side and clean side of the filter medium body are separated flow-tightly.

For producing the filter element, initially in a first step the filter element housing is produced, for example, as a monolithic injection molded plastic component or as a multi-part housing component that is assembled of individual parts. In a second step, the filter medium bodies are pushed into the respective receiving pockets on the filter element housing until the final position is reached.

It can be expedient to provide in each receiving pocket a circumferentially extending sealing rim on which the filter medium body is resting. The sealing rim is formed by a sealing element that, for example, is embodied as a sealing bead or as an adhesive bead or as PU foam and is extending along the outer contour of the filter medium body. The sealing rim is applied either in the form of a sealing mass along the inner contour of the receiving pocket, whereupon the filter medium body is pushed in until the outer contour of the filter medium body contacts the sealing mass; this produces, in addition to the flow-tight connection, also an adhesive connection of the filter medium body with the filter element housing. However, it is also possible to apply the sealing mass onto the outer contour of the filter medium body and to subsequently insert the filter medium body into the receiving pocket. The sealing mass in this context can be applied either as an adhesive bead in a not yet cured state, or it is in the form of a circumferentially extending sealing element that is arranged in the cured state on the outer contour of the filter medium body and, together with the latter, is inserted into the receiving pocket. Moreover, it is also possible to introduce a sealing element in the cured state into the receiving pocket and to subsequently insert the filter medium body into the receiving pocket.

The sealing rim is embodied to extend circumferentially and extends along the outer contour of the filter medium body in order to achieve a circumferential sealing action on the filter medium body. Advantageously, the sealing rim is located on the support rim on which the filter medium body is resting. However, it is also possible that the sealing rim laterally adjoins the support rim.

Different geometries and arrangements of the filter medium body on the filter element are conceivable. According to a first advantageous embodiment, the receiving pockets are positioned diametrically opposed on the filter element housing so that accordingly the inflow against the filter medium bodies is realized from the exterior to the interior, respectively, via diametrically opposed sides in the direction toward the clean chamber in the filter element housing, the clean chamber being positioned between the filter medium bodies. The receiving pockets including the filter medium bodies received therein are advantageously arranged without height displacement at the same level. Possible is however also a height displacement between the receiving pockets and the filter medium bodies. The flow direction through the two filter medium bodies extends parallel but oriented in opposite directions.

According to a further advantageous embodiment, the receiving pockets are located on the same side of the filter element housing so that also the filter medium bodies are arranged on the same side and inflow of the fluid to be purified occurs for them from the same side. The receiving pockets are positioned in this context preferably parallel to each other; they can have a spacing between them. The inflow sides of the filter medium bodies received in the receiving pockets can be positioned in one plane or can be positioned at a displacement relative to each other. The flow direction through the two filter medium bodies extends parallel and in the same direction.

According to a further expedient embodiment, the receiving pockets are arranged angularly relative to each other. In this context, embodiments are possible in which the receiving pockets are arranged at the same side of the filter element housing but are positioned at a slant relative to each other so that flow through the filter medium bodies is not parallel but angularly. Embodiments are also possible in which the receiving pockets are arranged on different sides of the filter element housing and are positioned angularly relative to each other. For example, it is possible to arrange receiving pockets at adjoining outer sides of the filter element housing that are positioned at an angle of 90° relative to each other, for example. Moreover, it is possible to provide the receiving pockets on diametrically opposed sides of the filter element housing but with an angular arrangement of the receiving pockets relative to each other wherein the angle is preferably not greater than 60°, preferably maximally 45° or maximally 30°, relative to a center plane through the filter element housing which intercepts preferably at a right angle the inflow side and/or outflow side, that are themselves planar, of the filter medium body.

The receiving pockets, according to a further expedient embodiment, are provided with a receiving wall that projects past the support surface or contact surface between receiving pocket and filter medium body and at least partially frames the circumferential sides of the received filter medium body. The receiving wall holds and stabilizes the filter medium body in the receiving pocket. Different embodiments of the receiving wall are possible in order to, on the one hand, hold the filter medium body safely and, on the other hand, provide an inflow surface that is as large as possible at the raw side of each filter medium body.

As needed, one or a plurality of lateral faces of the filter medium body which adjoin the inflow side can be utilized for inflow of the fluid. For example, it is possible for a filter medium body with rectangular basic cross section and a corresponding rectangular receiving pocket to provide one or both long sides or one or both short sides of the rectangular receiving wall of the receiving pocket with a reduced height. However, the reduced height is expediently sufficiently large in order to laterally support the filter medium body. As needed, it may be sufficient to provide only the corner areas of the receiving pocket with higher wall sections and the intermediately positioned areas between the corners with a reduced height of the receiving wall. According to a further embodiment, only on some of the sides a receiving wall is present, on the other sides there is however no receiving wall.

The filter medium body is advantageously of a parallelepipedal shape and comprises planar inflow and outflow sides as well as lateral faces.

The filter medium bodies are embodied advantageously as folded filters. However, it can also be advantageous to form the filter medium bodies as a compact filter block of a filter material.

It is possible to embody the filter medium bodies identically as well as differently, in particular in regard to their size and/or their geometry. For example, parallelepipedal filter medium bodies of different size can be employed.

The filter element with the at least two filter medium bodies forms a filter insert part that is insertable into a filter housing of a filter device.

### BRIEF DESCRIPTION OF THE DRAWINGS

Further advantages and expedient embodiments can be taken from the further claims, the description of the Figures, and the drawings.

FIG. 1 shows in exploded illustration a filter element with two parallelepipedal, separately embodied filter medium bodies and a filter element housing as a support body that has two diametrically opposed outwardly open receiving pockets for the filter medium bodies.

FIG. 2 shows the filter element according to FIG. 1 with the filter medium bodies inserted into the receiving pockets of the filter element housing.

FIG. 3 shows the filter element of FIGS. 1 and 2 in a section illustration.

FIG. 4 shows a filter element in an embodiment variant in which the receiving wall of the receiving pockets on the filter element housing has a reduced height on three sides.

FIG. 5 shows the filter element in a further embodiment variant in which the receiving wall of the receiving pockets has a greater height only in two corner areas.

FIG. 6 shows a filter element in a further embodiment variant embodied similar to FIG. 1, wherein the receiving wall along the longitudinal side of the receiving pockets is slightly higher than in FIG. 1.

FIG. 7 shows a section illustration of a filter element with diagonally opposed receiving pockets and filter medium bodies.

FIG. 8 shows a filter element in an embodiment variant in which diametrically opposed receiving pockets are oriented angularly relative to each other.

FIG. 9 shows a filter element in a further embodiment variant in which the receiving pockets and the inserted filter medium bodies are arranged at the same side of the filter element housing.

FIG. 10 shows a section view of the filter element according to FIG. 9.

FIG. 11 shows a filter element in a further embodiment variant in which, as in FIG. 9, both receiving pockets and filter medium bodies are positioned on one side, the outflow opening is however arranged below the filter medium bodies.

FIG. 12 shows a section view of the filter element according to FIG. 11.

FIG. 13 shows the contact surface between receiving pocket and filter medium body with inserted sealing mass.

FIG. 14 shows the contact surface between receiving pocket and inserted filter medium body which is provided with a raised portion that projects into a groove-shaped recess in the contact surface in the receiving pocket.

In the Figures, same components are provided with same reference characters.

### DESCRIPTION OF PREFERRED EMBODIMENTS

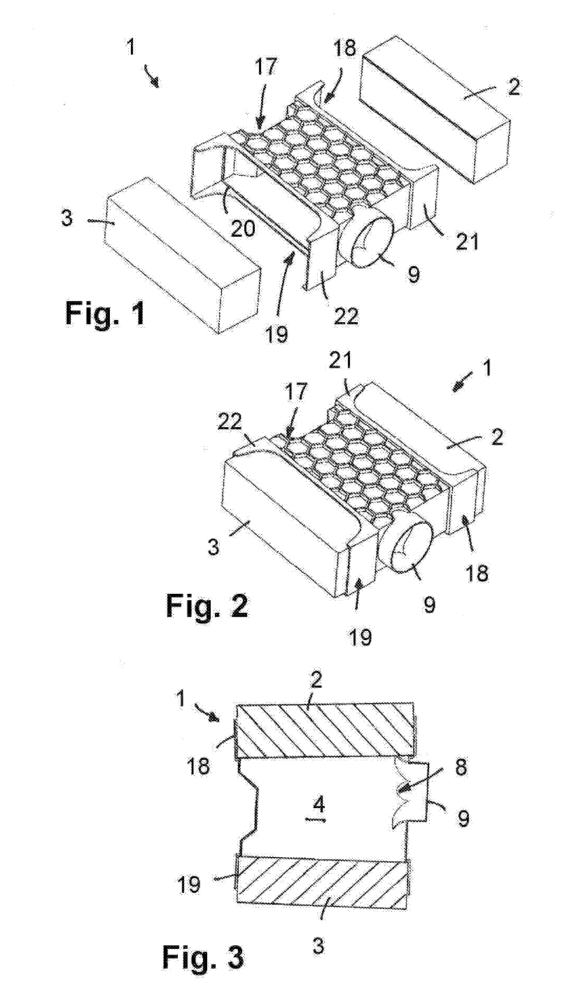

In FIGS. 1 to 3, a first embodiment with a filter element 1 for a filter device for gas filtration is illustrated. The filter element 1 forms a constructive unit and comprises a first filter medium body 2, a second filter medium body 3 as well as a filter element housing 17 that is configured as a support body and has on diametrically opposed sides receiving pockets 18, 19 and encloses an intermediately positioned clean chamber 4 (FIG. 3). The receiving pockets 18 and 19 serve for receiving the filter medium bodies 2, 3 and are embodied outwardly open so that the two filter medium bodies 2, 3 can be pushed from the exterior into the receiving pockets 18, 19. The receiving pockets 18, 19 adjoin immediately the clean chamber 4 in the filter element housing 17. The inflow into the filter medium bodies 2, 3 that are, for example, embodied as folded filters is from the exterior to the interior so that the outer side of the filter medium bodies 2, 3 is the raw side or inflow side and the side facing the clean chamber 4 is the clean side or outflow side.

The clean chamber 4 is enclosed by a bottom part, a cover part, and end face parts of the filter element housing 17; the outflow is realized through an outflow opening 8 and an outflow pipe 9 adjoining the outflow opening 8. Outflow opening 8 and outflow pipe 9 are located on the end face of the filter element housing 17 between the receiving pockets 18, 19 or the filter medium bodies 2, 3.

The inner contour of each receiving pocket 18, 19 is matched to the outer contour of each filter medium body 2, 3 to be received therein so that the filter medium bodies 2, 3 are safely and with form fit secured in the receiving pockets 18, 19. The receiving pockets 18, 19 have a rectangular cross section; the filter medium bodies 2, 3 are of parallelepipedal shape. The receiving pockets 18, 19 each have at their inner side facing the clean chamber a circumferentially extending support rim 20 in the form of a radially inwardly projecting circumferential projection on which the outer contour of each inserted filter medium body 2, 3 is supported. In the two directions transverse to the flow direction, the filter medium bodies 2, 3 are supported by the receiving walls 21 and 22 of each receiving pocket 18, 19 with form fit.

The receiving walls 21, 22 have in the embodiment according to FIGS. 1 to 3 at their two longitudinal sides a recess, respectively, so that the receiving wall at the longitudinal side has a significantly reduced height. The height is however sufficient for supporting the respectively received filter medium body 2, 3 even at this wall side. Due to the reduced height, the lateral faces of the filter medium body 2, 3 adjoining the inflow side are partially exposed and are utilized also for inflow of the unfiltered fluid.

Advantageously, a sealing mass is introduced into the support rim 20 and forms a circumferentially extending sealing rim in order to receive the inserted filter medium bodies 2 and 3 in a flow-tight manner. When the filter medium body 2, 3 is pushed into the receiving pocket 18, 19 with the sealing mass in the not yet cured state, an adhesive connection of the filter medium body with the filter element housing 17 is also achieved upon curing of the sealing mass.

As can be seen in the section illustration according to FIG. 3, the two receiving pockets 18, 19 and the parallelepipedal filter medium bodies 2, 3 received therein are positioned relative to each other at a small angle which is smaller than 10°. The two filter medium bodies 2, 3 are positioned at the same level; there is no height displacement between the filter medium bodies.

Due to the reduced wall height of the receiving wall 21, 22 at the receiving pockets 18, 19 in the area of the longitudinal side, the longitudinal circumferential side of the received filter medium body 2, 3 is accordingly also covered only partially by the receiving wall 21, 22. In this way, the inflow surface of each filter medium body 2, 3 is enlarged because not only the outer side which is facing away from or oppositely positioned to the clean chamber, but additionally also the two longitudinal circumferential sides can be used for the inflow. On the other hand, in the area of the narrow circumferential sides the height of the receiving wall 21 and 22 is not reduced; at this location, the receiving wall extends about most of the narrow circumferential side.

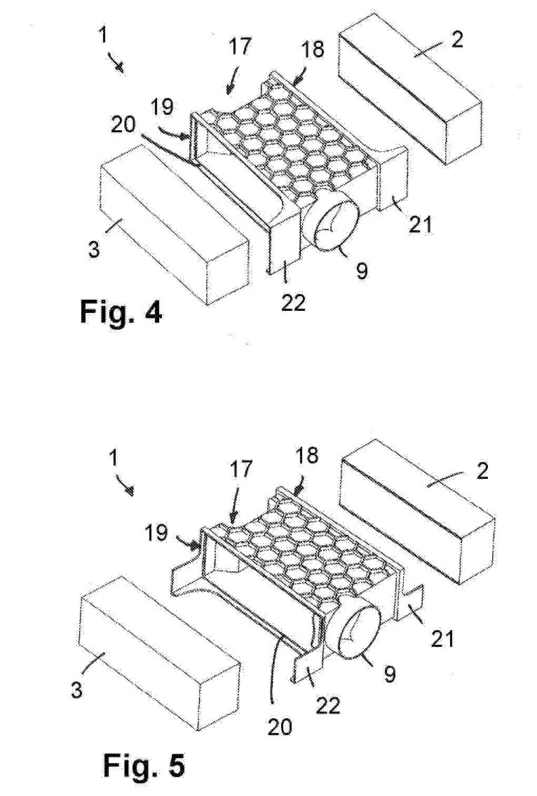

The embodiment according to FIG. 4 corresponds substantially to that according to FIGS. 1 to 3. Different is however the embodiment of the receiving pockets 18, 19 that have only in the area of a narrow side a receiving wall 21, 22 of greater height while on the remaining three sides the receiving wall has a significantly reduced height. Accordingly, inflow of the fluid to be purified is possible additionally at three circumferential sides or lateral faces of the filter medium bodies 2, 3 inserted into the receiving pockets 18, 19.

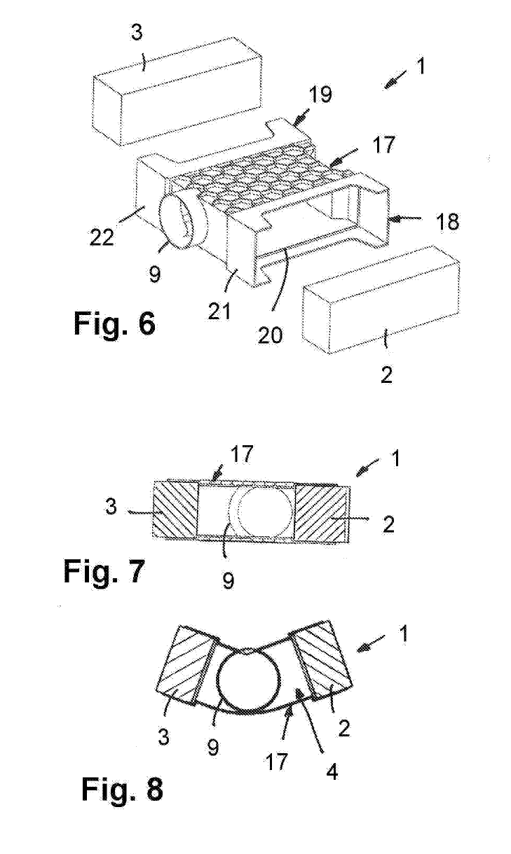

In the embodiments according to FIGS. 5 and 6, the filter element 1 is of a similar configuration as in the afore described embodiments. In FIG. 5 however, each receiving pocket 18, 19 is designed with two higher corner sections in the receiving walls 21, 22 while the remaining wall sections have only a significantly reduced height. The two corners sections are positioned at the same longitudinal side. This embodiment makes it possible that the fluid to be purified can flow into the filter medium bodies 2, 3 at each circumferential side or lateral face and also in both corner areas where the receiving wall 21, 22 has only a reduced height.

The embodiment according to FIG. 6 corresponds substantially to that of FIG. 1 but with the difference that the receiving wall 21, 22 in the area of the longitudinal circumferential side of each receiving pocket 18, 19 in comparison to FIG. 1 has a somewhat greater height which however is smaller than the height of the receiving wall in the area of the narrow sides. In this way, an improved support of the received filter medium bodies 2, 3 is provided on the longitudinal sides.

In FIG. 7, a section view of a filter element according to the afore described embodiments is illustrated. The two receiving pockets and the inserted filter medium bodies 2, 3 are located on diametrically opposed sides of the filter element housing 17 at the same level.

In FIG. 8, an embodiment variant is illustrated in which the receiving pockets in the filter element housing 17 and the filter medium bodies 2, 3 inserted therein are also arranged on diametrically opposed sides but are oriented angularly relative to each other. The angle is approximately 30° in the embodiment. Also, the clean chamber 4 has a curved bottom and a curved cover.

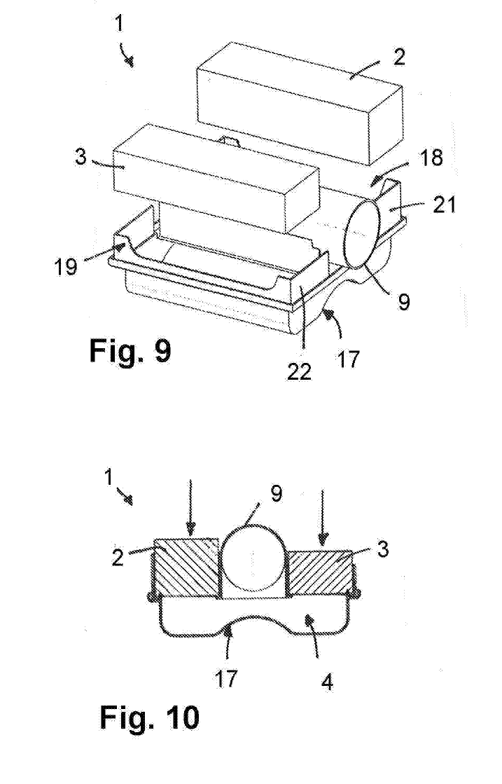

In FIGS. 9 and 10, a further embodiment of a filter element 1 is illustrated in which the two receiving pockets 18 and 19 as well as the filter medium bodies 2, 3 are arranged on the same side of the filter element housing 17. The fluid to be purified flows in the same direction against the filter medium bodies 2, 3, as illustrated in FIG. 10 by the arrows. The filter medium bodies 2, 3 are of different size; they have the same length and width but a different height. The receiving walls 21 and 22 are matched to the different height of the filter medium bodies 2, 3; the receiving wall 21 of the receiving pocket 18 is provided for the bigger filter medium body 2 with a greater height than the receiving wall 22 of the receiving pocket 19 for the smaller filter medium body 3.

The clean chamber 4 is located on the side opposite the inflow sides; the outflow pipe 9 that adjoins the outflow opening is positioned in the intermediate area between the two receiving pockets 18, 19 or the filter medium bodies 2, 3 received therein.

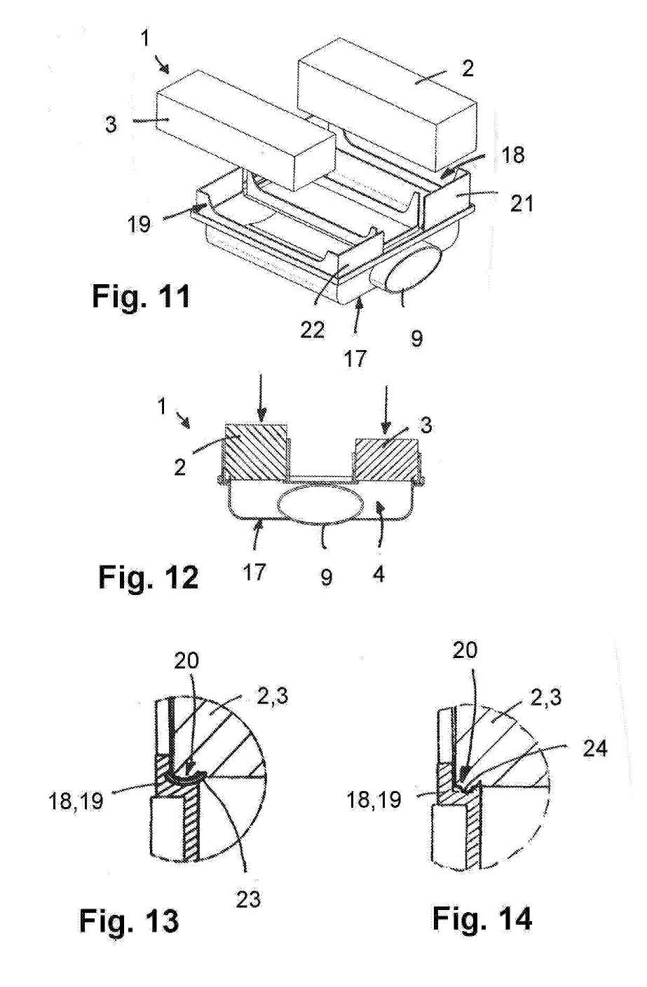

In the embodiment according to FIGS. 11 and 12, the two receiving pockets 18, 19 are also positioned on the same side of the filter element housing 17 so that the fluid to be purified also flows from the same side, according to the arrows shown in FIG. 12, against the two filter medium bodies 2, 3 received in the receiving pockets 18, 19. In contrast to the preceding embodiment, the outflow pipe 9 as well as the outflow opening 8 are however not arranged between the receiving pockets 18, 19 but below the receiving pockets 18, 19. The area which is located immediately between the two receiving pockets 18, 19 is not occupied.

FIGS. 13 and 14 show a respective detail enlargement of the filter element 1 with the support rim 20 on which the filter medium body 2, 3 is resting in the correlated receiving pocket 18, 19. In FIG. 13, on the support rim 20 a sealing rim 23 of a sealing material is provided that, for example, is applied in the not yet cured state onto the support rim 20 in the receiving pocket whereupon the filter medium body 2, 3 is inserted. With curing of the sealing mass, the received filter medium body is glued to the receiving pocket; at the same time, a flow-tight connection is achieved.

In the embodiment according to FIG. 14, in the support rim 20 a groove-shaped circumferential recess 24 is provided into which a corresponding raised portion is projecting which is provided in the rim area of the filter medium body 2, 3. As needed, a sealing mass can be introduced into the recess 24.

What is claimed is:

1. A filter element comprising:
a filter element housing comprising a first outwardly open receiving pocket and a second outwardly open receiving pocket;
a first filter medium body disposed in the first receiving pocket;
a second filter medium body disposed in the second receiving pocket;
wherein the first and second filter medium bodies delimit a common clean chamber that communicates with at least one outflow opening configured to discharge a purified fluid from the clean chamber;
wherein the first receiving pocket comprises a circumferentially extending first support rim on which the first medium body is supported;
wherein the second receiving pocket comprises a circumferentially extending second support rim on which the second filter medium body is supported;
wherein the first receiving pocket comprises a first receiving wall at least partially enclosing the first filter medium body and extending outwardly away from the first support rim;
wherein the second receiving pocket comprises a second receiving wall at least partially enclosing the second filter medium body and extending outwardly away from the second support rim.

2. The filter element according to claim 1, wherein the first receiving pocket has a circumferentially extending first sealing rim on which the first filter medium body is resting and wherein the second receiving pocket has a circumferentially extending second sealing rim on which the second filter medium body is resting.

3. The filter element according to claim 2, wherein the first and second sealing rims are embodied as an adhesive bead and the first and second filter medium bodies are adhesively connected to the adhesive bead, respectively.

4. The filter element according to claim 2, wherein the first and second sealing rims are embodied as PU foam.

5. The filter element according to claim 2, wherein the first sealing rim is positioned on or adjacent to the first support rim and wherein the second sealing rim is positioned on or adjacent to the second support rim.

6. The filter element according to claim 1, wherein the first and second receiving pockets are arranged diametrically opposed to each other on the filter element housing.

7. The filter element according to claim 1, wherein the first and second receiving pockets are arranged on the same side of the filter element housing.

8. The filter element according to claim 1, wherein the first and second receiving pockets are arranged on different sides of the filter element housing and are arranged angularly relative to each other.

9. The filter element according to claim 1, wherein at least one side of the first and second receiving walls has a reduced height, respectively.

10. The filter element according to claim 9, wherein at least the first receiving pocket has a rectangular cross section.

11. The filter element according to claim 10, wherein the first receiving wall has a rectangular cross section with two long sides and two narrow sides, wherein at least one of the long sides of the first receiving wall has a reduced height relative to a height of the narrow sides.

12. The filter element according to claim 1, wherein at least one of the first and second filter medium bodies has a parallelepipedal shape.

13. The filter element according to claim 1, wherein the first and second filter medium bodies are folded filters.

14. The filter element according to claim 1, wherein the first filter medium body has a size that is different from a size of the second filter medium body.

15. The filter element according to claim 1, wherein the first filter medium body has a geometry that is different from a geometry of the second filter medium body.

16. The filter element according to claim 1, wherein the first filter medium body has a size and a geometry different from a size and geometry of the second filter medium body.

17. The filter element according to claim 1, wherein the filter element housing is a monolithic injection molded plastic part comprising the first and second receiving pockets.

18. A filter device with a filter element according to claim 1 and a filter housing configured to receive the filter element.
